(19) United States
(12) Patent Application Publication
(10) Pub. No.: US 2007/0246114 A1
(43) Pub. Date: Oct. 25, 2007

(54) End Cap For Product Container

(76) Inventor: Richard Mazurek, Huntingdon, PA (US)

Correspondence Address: MEADWESTVACO CORPORATION, 1021 MAIN CAMPUS DRIVE, 3RD FLOOR, CENTENNIAL CAMPUS, RALEIGH, NC, 27606, US

(21) Appl. No.: 11/690,541

(22) Filed: Mar. 23, 2007

Related U.S. Application Data
(60) Provisional application No. 60/743,680, filed on Mar. 23, 2006.

(51) Int. Cl. F16L 55/10

(52) U.S. Cl. 138/89

(57) ABSTRACT

An end cap (100) is insertable into an open end of a sleeve (12) as an end closure for forming a package (10). The end cap (100) has a housing (102) that is adapted to be closely received by the sleeve (12) and that terminates at a first end in a flanged perimeter (104). The end cap (100) also has a strut structure (120) extending between regions of the housing (100) so as to reinforce the housing (100) against deformation. The strut structure (120) may extend between regions of the housing (102) proximate the flanged perimeter (104). The strut structure (120) may take the form of a cover that is affixed to the flanged perimeter (104) of the housing (102). The cover (120) may have a perimeter (124) with an interior portion (122) extending therebetween. The perimeter (124) of the cover may be affixed to the flanged perimeter (104) of the housing (102).

### CROSS-REFERENCE TO RELATED APPLICATIONS

This application claims the benefit of priority under 35 U.S.C. §119(e) of U.S. provisional application Ser. No. 60/743,680 filed on Mar. 23, 2006, which is hereby incorporated by reference in its entirety.

### TECHNICAL FIELD OF THE INVENTION

The invention relates to the field of product packaging, and more particularly to a reinforced end cap for a product container.

### BACKGROUND OF THE INVENTION

Product packaging is useful for the distribution, display and sale of products. A particularly useful product package is a product container with an end cap that was co-invented by the inventor of the present application. That product container was the subject of U.S. Patent Application Publication Number 2003/0226770, published Dec. 11, 2003, which publication is herby incorporated by reference. The underlying Patent Application for the Publication is U.S. patent application Ser. No. 10/164,477, filed Jun. 6, 2002, which issued as U.S. Pat. No. 7,000,775 on Feb. 21, 2006. That Patent Application and Patent are assigned to the same assignee, that is, MeadWestvaco Corporation, as the present application.

The product container of the above-referenced patent application Ser. No. 10/164,477 includes a sleeve having at least one opening. Inwardly-folded locking tabs extend from the sleeve at the opening. An end cap is closely received by the sleeve. A rim around the perimeter of an end of the end cap prevents the end cap from being fully inserted in the sleeve, beyond the rim. Channels in the end cap engage the locking tabs of the sleeve to inhibit removal of the inserted end cap. The. container is opened by twisting or rotating the end cap and sleeve with respect to one another so that the channels of the end cap and the locking tabs of the sleeve are urged out of alignment with and away from one another.

In another aspect, an end of the container is configured to be non-openable. The container is made non-openable through use of an end cap that is non-twistable or non-rotatable with respect to the sleeve, and hence non-removable from the sleeve. The locking tabs and the cap design that are disclosed in the published application are elements that contribute to the non-openable format.

The operation of the container depends upon the sleeve being flexible and resilient, but at the same time, the end cap (removable or non-removable) being at least slightly more rigid than the sleeve.

Manufacturers and distributors often desire to reduce the cost of packaging. A typical means of reducing the cost of packaging is to use less expensive materials to construct the packaging or parts thereof, or use less expensive manufacturing processes, or both. Less expensive materials are typically thinner or less substantial, and, therefore, less rigid, than their more expensive counterparts. Less expensive manufacturing processes often require the use of less substantial materials or otherwise result in the creation of a product that is less substantial, and, therefore, less rigid, than packaging products produced by more expensive processes. In the case of the sleeve-and-end-cap product container described above, end caps are typically made of expensive materials or by expensive methods.

Therefore, it can be appreciated that it would be useful to have an end cap that possesses sufficient rigidity for use in the above-described container. It can be further appreciated that it would be useful to have an end cap that is produced using less expensive manufacturing materials, or that can be produced by less expensive manufacturing processes, or both, but that possesses sufficient rigidity to be operable in the above-described container.

### BRIEF SUMMARY OF THE INVENTION

In accordance with one aspect of the invention, an end cap is an end closure for a sleeve that has at least one open end, the end closure has a housing that terminates at a first end in a flanged perimeter and has a strut structure extending between regions of the housing so as to reinforce the housing against deformation.

In accordance with another aspect of the invention, the strut structure extends between regions of the housing proximate the flanged perimeter.

In accordance with a further aspect of the invention, the strut structure is a cover affixed to the flanged perimeter of the housing.

In accordance with an additional aspect of the invention, the cover is affixed to the flanged perimeter of the housing by application of electromagnetic radiation heat energy.

In accordance with an additional aspect of the invention, the electromagnetic radiation heat energy is radio-frequency electromagnetic radiation.

In alternative embodiments, the strut structure is bonded to the housing with adhesive or attached to the housing with a friction fit. Further alternative embodiments include the package components being constructed of plastic, paper, paperboard, laminates thereof, and the like.

### BRIEF DESCRIPTION OF THE DRAWINGS

FIG. 1 is a perspective view of an exemplary embodiment of an end cap inserted within a sleeve to form a product container, in accordance with the present invention.

FIG. 2 is a partial, exploded view of an exemplary embodiment of an end cap, withdrawn from a sleeve, and a cover for the end cap separated from the end cap housing, in accordance with the present invention.

FIG. 3 is a top plan view of an exemplary embodiment of a cover for an end cap for a product container, in accordance with the present invention.

FIG. 4 is an elevation view of an exemplary embodiment of a cover for an end cap for a product container, in accordance with the present invention.

### DETAILED DESCRIPTION

Detailed embodiments of the present invention are disclosed herein. The disclosed embodiments are merely exemplary of the invention that may be embodied in various and alternative forms, and combinations thereof. As used herein, the words “exemplary” and “illustrative” are used expansively to refer to embodiments that serve as illustrations, specimens, models or patterns. The figures are not necessarily to scale and some features may be exaggerated or minimized to show details of particular components. In other instances, well-known components, systems, materials or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention.

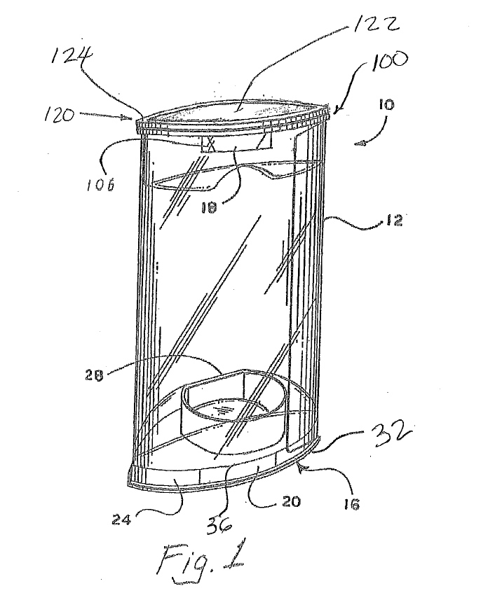

Referring to FIG. 1, an exemplary embodiment of an end cap 100, also referred to herein as an “end closure,” is inserted in a sleeve 12 to form a product container or package 10, in accordance with the present invention. The complete package/container 10 is formed by a sleeve 12 having an end cap disposed in at least one end thereof; however, as an alternative, and as shown in the exemplary embodiment, end caps 100, 16 can be disposed at both ends of the sleeve to form a fully-enclosed package.

In the exemplary embodiment shown in FIG. 1, the lower end of the sleeve 12 has a non-releasable end cap 16. A rim 32 of the end cap 16 engages the lower end of the sleeve 12 and prevents the end cap 16 from being fully inserted into the sleeve 12. A non-releasable locking mechanism that prevents withdrawal of the end cap 16 of the lower end of the sleeve 12 is formed in-part by locking tabs 20 of the sleeve 12 that cooperatively rest within a channel 24 of the end cap 16. The locking mechanism is completed by a ledge 36 that defines a perimeter of the channel 24 of the end cap 16. The ledge 36 engages the locking tabs 20 to ultimately inhibit removal of the end cap 16. A compartment 28 for receiving an article may also be provided in the end cap 16. In some embodiments, end caps at opposite ends of a sleeve are both of the non-releasable type, to form a package that does not permit easy access to the contents.

Referring now to FIG. 1 and to FIG. 2 simultaneously, an exemplary embodiment of an end cap 100, or closure, in accordance with the present invention will be described in greater detail. The exploded view of FIG. 2 shows the details of the exemplary embodiment of the end cap 100 of FIG. 1 more clearly. The releasable end cap 100 includes a walled housing 102 adapted for being closely received by the sleeve 12. For example, the housing 102 may have a cross-sectional configuration corresponding to the cross-sectional configuration of the sleeve 12, as illustrated, so that the housing 102 can be closely received by the sleeve 12. The housing 102 may be at least slightly elongated, which facilitates insertion of the end cap 100 into the sleeve 12. The perimeter of one end of the housing 102 includes a rim 104. The rim 104, which is a flange-like element, is adapted to engage the end of the sleeve 12 to prevent full insertion of the end cap 100. The housing 102 has channels 106 that are adapted to cooperatively engage the locking tabs 18 at the upper end of the sleeve 12. The lower end of the housing 102, which is inserted into the sleeve 12, is shown as a closed end 108, but can be constructed in an open configuration without departing from the teachings of the present invention.

The housing 102 is reinforced by a strut structure 120 that extends between regions of the housing 102. The strut structure 120 may extend between regions of the housing 102 proximate the opening where the flanged perimeter 104 of the housing 102 is formed. In the exemplary embodiment of the end cap 100 illustrated, the strut structure 120 extends between regions of the housing 102 by being affixed to the flanged perimeter 104 of the housing 102.

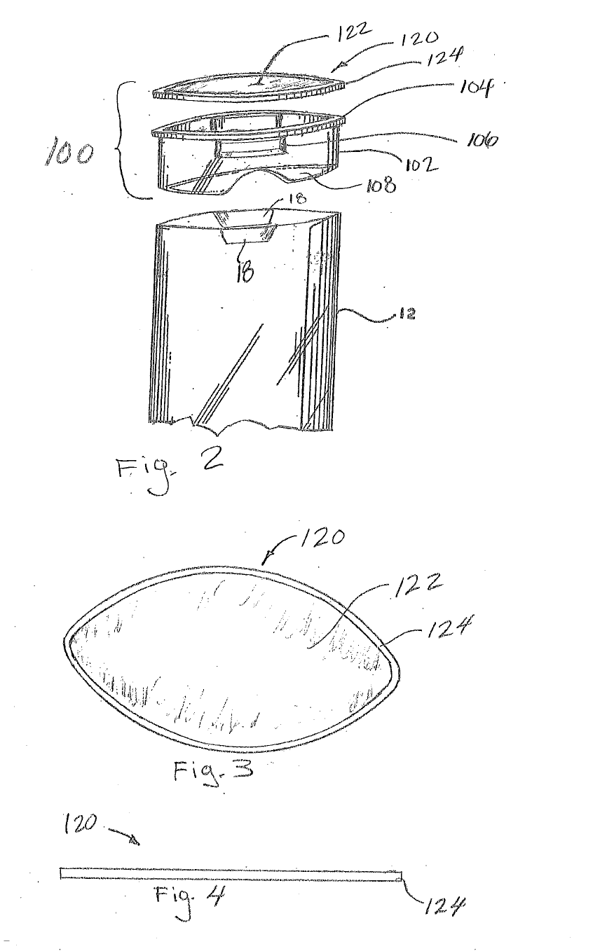

Referring simultaneously to FIGS. 3 and 4, an exemplary embodiment of a strut structure 120 is a cover having a perimeter 124 and an interior portion 122. The cover strut structure 120 is adapted to be attached to the rim 104 of the housing 102. Although the strut structure 120 may take many forms, it is characterized in that it supports the wall portions of the housing 102 to provide structural integrity and rigidity. When applied at the upper portion of the housing 102 the strut structure 120 provides sufficient rigidity to enable the releasable end closure/cap 100 to be twisted without deformation, and, at the same time, cause the sleeve 12 to deform to facilitate release of the end cap 100 from the sleeve 12.

Use of a reinforced end cap, as taught by the present invention, at the non-openable end of the package provides a closure that maintains its form and position without being easily deformed.

An end cap 100, 16 produced in accordance with the teachings of the present invention can be made from a variety of materials and by a variety of manufacturing processes; however, the teachings of the present invention are particularly useful when applied to end caps made by a thermoforming process. Plastics manufacturing that utilizes a thermoforming process typically provides an end product that is less expensive to create than other plastics manufacturing processes, such as injection molding. Thermoforming provides benefits over an injection-molding process. A cost advantage of thermoforming is that less raw material is typically used than in other processes, such as injection molding. Another advantage is the cost saving of making a mold to manufacture the part. The cost of a mold for thermoforming can be as little as 14% of the cost of a mold for injection molding. In addition, there is a yield advantage in that a thermoforming process can produce as many as 3½ times the number of items that can be produced during an injection-mold shift operation.

A potential disadvantage of a thermoformed end cap is that it may lack sufficient rigidity to provide an end closure structure that cannot be breached easily or that will not be deformed easily when twisted. The strut structure 120 provides the necessary rigidity for the end cap to resist deformation. The cover strut structure 120 provides a simple, unitary means for reinforcing the housing 102.

The strut structure 120 can be made and incorporated into the housing 102 by a variety of manufacturing methods or processes. For example, the strut structure can be integrally formed with the housing 102. As a further example, the strut structure can be integrally formed with the housing as a part of a thermoforming process.

The strut structure may be formed separately by a variety of processes, and then affixed to the housing. For example, the strut structure may be independently formed by any process, including thermoforming, and then affixed to a housing. In addition, the strut structure 120 can be formed by cutting or otherwise forming a substrate sheet into a configuration corresponding to the shape of the perimeter of the upper, open end of the housing 120. The substrate can be selected from materials including, but not limited to, plastic, paper, paperboard, laminates thereof, and the like.

The cover strut structure 120 can be affixed to the housing 102 by a variety of processes for joining one article or component to another. Such processes include those processes suitable for joining plastic to plastic, paper to paper, paperboard to paperboard, or joining any combination thereof. In addition, if the housing 102 and cover strut structure 120 are both made by thermoforming, they will both consist of material, such as plastic shaped by thermoforming, suitable for joining to one another by use of radio-frequency (RF) electromagnetic radiation heating and sealing. Alternative methods of joining the housing 102 and cover strut structure 120 both formed from plastic include sonic sealing and adhesive bonding. In addition, the housing 102 and cover 120 can be adapted and configured as complementing interlocking parts that can be joined by pressing one into the other.

The strut structure 120 can extend between regions of the housing 102 other than at the upper end of the housing 102, whether or not it is integrally formed with the housing 102.

Another advantage of the present invention when the strut structure 120 is configured as a cover is that, the interior of the housing 102 may be used as a compartment for a complementary article. Another advantage of using a strut structure in the form of a cover 120 is that the outer or inner surface of the interior portion 122 of the strut structure/cover 120 may be used for displaying written or graphic indicia.

The law does not require and it is economically prohibitive to illustrate and teach every possible embodiment of the present claims. Hence, the above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

What is claimed is:

1. An end closure for a sleeve having at least one open end, the end closure comprising:
a housing adapted for being closely received by the sleeve, terminating in a flanged perimeter at a first end and having a strut structure extending between regions of said housing so as to reinforce said housing against deformation.

2. The end closure of claim 1, wherein said strut structure extends between regions of said housing proximate said flanged perimeter.

3. The end closure of claim 1, wherein said strut structure comprises a cover affixed to said flanged perimeter of said housing.

4. The end closure of claim 3, wherein said cover comprises a cover perimeter having an interior portion extending therebetween.

5. The end closure of claim 4, wherein said cover perimeter is affixed to said flanged perimeter of said housing.

6. The end closure of claim 3, wherein said cover is affixed to said flanged perimeter by application of electromagnetic radiation heat energy.

7. The end closure of claim 6, wherein said electromagnetic radiation comprises radio-frequency (RF) electromagnetic radiation.

8. The end closure of claim 1, wherein said housing is thermoformed.

9. A package comprising:
a sleeve having at least one open end; and
an end closure comprising:
a housing adapted for being closely received by the sleeve, terminating in a flanged perimeter at a first end; and
a strut structure extending between regions of said housing so as to reinforce said housing against deformation.

10. The end closure of claim 9, wherein said strut structure extends between regions of said housing proximate said flanged perimeter.

11. The end closure of claim 9, wherein said strut structure comprises a cover affixed to said flanged perimeter of said housing.

12. The end closure of claim 11, wherein said cover comprises a cover perimeter having an interior portion extending therebetween.

13. The end closure of claim 12, wherein said cover perimeter is affixed to said flanged perimeter of said housing.

14. The end closure of claim 11, wherein said cover is affixed to said flanged perimeter by application of electromagnetic radiation heat energy.

15. The end closure of claim 14, wherein said electromagnetic radiation comprises radio-frequency (RF) electromagnetic radiation.

16. The end closure of claim 9, wherein said housing is thermoformed.

17. A package comprising:
a sleeve having:
at least one end defining an opening, and
at least one locking tab extending from and folded inwards into said opening, said at least one locking tab having a locking edge; and
an end closure having:
a housing adapted for being closely received by said sleeve, terminating in a flanged perimeter at a first end and having at least one channel corresponding to and adapted for receiving said at least one locking tab, said at least one channel having a ledge adapted for engagement within said locking edge of said locking tab to inhibit removal of said housing from the sleeve opening, and
a strut structure extending between regions of said housing so as to reinforce said housing against deformation.

18. The package of claim 17, wherein said at least one locking tab disengages from said at least one channel when said housing and said sleeve are axially rotated with respect to one another.
